(19) United States
(12) Patent Application Publication
(10) Pub. No.: US 2007/0269782 A1
(43) Pub. Date: Nov. 22, 2007

(54) Instructional game program and method

(76) Inventor: Melinda Kathryn Puente, San Antonio, TX (US)

Correspondence Address: Melinda Kathryn Puente, Suite 12116, 8603 N. W. Loop 1604, San Antonio, TX, 78249, US

(21) Appl. No.: 11/654,429

(22) Filed: Jan. 17, 2007

Related U.S. Application Data
(60) Provisional application No. 60/759,318, filed on Jan. 17, 2006.

(51) Int. Cl. G09B 19/00

(52) U.S. Cl. 434/219

(57) ABSTRACT

An instructional game for transferring compliance knowledge to practice for mandatory or rule-based equipment procedure and task requirements. One exemplary embodiment of the invention utilizes a game architecture developed around a morphological field analysis of parameters that can influence compliance adherence. The process of designating parameters and defining relationships between the values of the parameters on the basis of internal consistency (standards and cognitive constructs) and cause and effect or causes that affect (performance/normative standards) supported through machine processing serves as the core structure of the game. This structure is used to generate in-game object and path determination, strategies and scenarios for development, post game performance assessment, probable non-compliant analysis and multiple play service provision, useful for communicating protection and prevention information.

### PRIORITY CLAIM

This application claims priority of U.S. Provisional Patent Application Ser. No. 60/759,318, entitled “AN INSTRUCTIONAL GAME PROGRAM AND METHOD” filed Jan. 17, 2006, the teachings of which are incorporated herein by reference.

### FIELD OF THE INVENTION

This application relates generally to electronic instructional/gaming and is particularly directed at the transfer of compliance knowledge to practice for mandatory or rule-based equipment procedure and task requirements.

### BACKGROUND OF THE INVENTION

Within the last decade, research has focused on the significance of human/object interaction, and the consequence of noncompliant practice. In management and the software industry, compliance can mean adhering to and demonstrating conformity to a standard (i.e. code of conduct) or regulation. In medicine, compliance can mean adherence to a recommended course of treatment and accomplishment of self-regulation can mean adherence to self-assigned parameter's (i.e. reduce consumption by x amount to lose weight or stop smoking). Consequences of non-conformity not only impact the individual but often have significant implications for society

While the above domains differ in knowledge structure and involve a plurality of factors that impact compliance, what is universal is the often failure of individuals to adhere to a determinate method, prescribed treatment, rule-based policy or self-assigned parameter due to a lack of understandability. Most commonly reported causes for poor compliance involving overall instructions include: regimens too complicated to understand, instructions not clear to execute, purpose of instructions not clear to induce reasoning, physical difficulty in applying instruction and forgetfulness.

To date, the general provision of instructional information appears to have been limited in the ability to transfer compliance knowledge to practice. However, technology enhanced benefits of utilizing pedagogic principles within a 3-D game structure, present opportunities to enhance the transfer of compliance knowledge to practice. Empirical research has reported that games have been found to provide a more meaningful environment for problem-based learning. As problem solving can be associated with discovery learning, synthetic environments such as games allow users to discover new rules and ideas rather than memorizing or forgetting information. Simulation games also offer possibilities for users to interact with the game by exploring and manipulating objects in order to test new hypotheses without the potential for actual harm. These game characteristics are believed to be most useful for prevention and intervention efforts for adherence to compliance.

Successfully immersing educational material into an electronic game without disturbing the inherent features and concepts of game play, are believed capable of transforming games into a channel for information dissemination. In that the purpose of many mobile applications is to obtain context-aware information for personal help; the easy access to compliance information through multiple communication platforms is believed to better suit the needs of the mobile population.

As it pertains to this invention, these opportunities can include: intuitive communication of risks, faster retention of procedures and tasks and increased validation of policy or law in that self-evaluative reactions brought about by consequential results enhance reasoning. Additionally, the use of game techniques can motivate, aid understanding and enhance knowledge and skill acquisition needed to transfer knowledge to practice.

The disclosed methods and systems include instructional gaming comprising: customization, demonstrations, real-time and practice simulations and experiential gaming scenarios that portray effects of actual consequential effects and results from player/learner responses and the addition of an executable self-monitoring and recordkeeping/reporting application. Player's that perform or respond inaccurately, inappropriate or untimely in demonstration, simulation or experiential game sequences may loose virtual resources as the result of unplanned consequences that can include: fines, job loss, shut-downs or incarceration or expend public dollars through emergency support resources. In addition, third-party costs resulting from harm to humans and the environment or other resources as appropriate to the specific learning domain are also tallied. In some embodiments, site-specific images of domain specific objects can be imported into the game to customize game sequences. In other embodiments, direct interface with a lexicon of user specific objects and or combinations of image transfer access can be used. In other embodiments self-monitoring can be supported through user-specific images, animation and/or self-assigned user notification. In other embodiments required data forms for reporting can be supported through site-specific images and animation.

While the most often reported use of games is an entertainment divergence, the divergence characteristic for the present invention is a method, accessed through ubiquitous multiplatform delivery, to deter (through practice or real-time application), the performance of uncertain or unsafe human/object interaction(s) defined by rules of law, policy standards and/or standards of treatment, requiring intellectual skill through acquired knowledge to accurately identify and implement decisions within a simulated reality that are determined to be compliant.

### SUMMARY OF INVENTION

The present invention achieves technical advantages as an instructional game for transferring compliance knowledge to practice for mandatory or rule-based equipment procedure and task requirements. One exemplary embodiment of the invention utilizes a game architecture developed around a morphological field analysis of parameters that can influence compliance adherence. The process of designating parameters and defining relationships between the values of the parameters on the basis of internal consistency (standards and cognitive constructs) and cause and effect or causes that affect (performance/normative standards) supported through machine processing serves as the core structure of the game.

The structure is used to generate in-game object and path determination, strategies and scenarios for development, post game performance assessment, probable non-compliant analysis and multiple play service provision, useful for communicating protection and prevention information. Regulations, codes (ICHI, ICD-9, codes of conduct) and self-assigned parameters and instruction level, serve as normative constraints for the system. Specific task, procedures and cognitive constructs are then indexed on the morphological field to specify and create game scenarios for respective standard parameters, determine performance assessment subsequent to game play/interaction and identify the likelihood of communication delivery methods regarding probable nonconformity.

Field parameters (Tasks/Procedures or T/P) include: standards, regulations, self-assigned parameters and cognitive construct states pre-assigned to game levels and indexed to type of object, type of hand manipulation, sequence of performance, type of result, type of consequence, type of resource loss, recordkeeping, self-monitoring and technology conversion. General values as they relate to the game logic for the morphological field include: Task/Procedures: (i.e. industry codes, codes of conduct), policies (i.e. adherence to code of conduct, steps in applying for a loan for an auto purchase to maintenance policy for continued warranty) and self-assigned requirements (i.e. stop smoking or loose weight); cognitive constructs to support procedural knowledge transfer to practice: understand, create, analyze, apply evaluate and remember and corresponding cognitive processes; type of objects utilized in task/procedure: static or dynamic; hand manipulation of object: grip, grasp; performance results: inaccurate, inappropriate or untimely; consequences: personal, professional, financial, resource loss: impact health, illness, injury or death; environment, water, soil or air contamination, property or equipment; Personal, Financial, Litigation, 3^{rd} party; monitoring: real time, self-monitoring; reporting: mandatory (form) or self-assigned (file); technology convergence: internet, telephone, television and wireless.

In Game Level 1 (Demonstration) cognitive processes (CC) that can support the transfer to practice of understanding (CC1=exemplify, CC2=infer, CC3=explain, CC4=summarize, CC5=interpret, CC6=classify, and CC7=compare), are combined with the required tasks/procedures to create Level 1 scenarios.

In Game Level 2, (Practice simulation) cognitive processes that support the transfer to practice of analysis and evaluation (CC8=differentiate, (CC9=organize, CC10=attribute, CC11=checking, CC12=critique) are combined with the required T/Ps to create Level 2 scenarios.

In Game Level 3 (Experiential), cognitive processes that support the transfer to practice of Creation and Application (CC13=hypothesis generation, CC14=planning, CC15=implementing plan, CC16=executing task, CC17=implementing) are combined with the required T/Ps to create Level 3 scenarios.

In Game Level 4 (Monitoring), cognitive processes that support the transfer to practice of Remembering (CC18=recall and CC19=retrieve), are combined with the required T/Ps to create Level 4 scenarios.

Under the rules of the present invention, scoring for Level 1 is determined by the correct recall of knowledge inquiries. A critical chain method (CPM) is determined to be the normative standard upon which timely and or inappropriate (a priori sequence) player performance is assessed for Practice and Experiential levels. The CPM algorithm is used to determine procedure/task duration based upon both time and resource dependencies, continuous monitoring of the player's performance, resource loss and tracking of key and non-significant actions within the T/P sequence. In addition, CPM enables future stochastic predictions. Deviations from the normative order of the sequence results in untimely performance and a lower score, new sequence steps not in the critical chain are determined to be inappropriate and also result in a lower score.

In contrast, the inverse of correct procedure and task sequences are combined in an impact matrix to generate incorrect scenarios. Player performance contrary to normative sequences, are incorrect and cause reduction in the player's score. While qualitative assessment of consequences are presented to the player for comparison, checking and critique against normative standard representation, all inappropriate, untimely and incorrect performance results in consequences that are correlated with financial resource loss.

Electronic game mechanics of the instructional game are based on resource management. Resource management includes establishing relative values for available resources as the rules and structure of the game that can include: currency, time, physical assets, profitability or health status.

In the present invention, resource management entails a resource that determines the type and amount of resource the player maintains and how many losses the player avoids. Losses can include personal finance, professional effects, third-party financial costs and human health status or environmental harm.

Depending upon domain knowledge, particular key resources are given to the player to maintain. For example, in most cases financial loss is a primary consequence of most non-compliance; therefore a virtual bank account is a key resource. The maintenance of a virtual bank account therefore becomes the player's responsibility as well as a visual reminder of the financial consequences of non-compliance. If on the other hand health status is the key resource, a virtual image of a human figure or specific parts of the body is added to the resource key to become the visual reminder of the health consequences of non-compliance. Throughout the gaming sequences the player will monitor the Resource Management Key (hereafter referred to as the “RMK”) for this information.

Instructional game levels for procedure and task requirements can include demonstrations, real-time or practice/rehearsal simulations and experiential methods to achieve a systematic approach to enhance compliance knowledge transfer to practice. Learning techniques of the present invention are based on observational and experiential learning and gaming techniques and supported through pedagogic cognitive process dimensions, whereby the player can observe and interact with mandatory or rule-based step-by-step, object, human interaction procedure and task manipulation requirements and respond to results and consequences.

The presentations include: scientific animations and simulations or real-time interaction. Scientific animation is used to describe a more technically based presentation whereby objects and environments are properly and consistently scaled and trajectories and velocities are based on the laws of physics and the appropriate equations of motion. Simulations, also based on the laws of physics, contain specific underlying equations that can predict an outcome.

The observational learning sequences begin with a demonstration of the mandatory or rule-based procedure/task requirements. Through cinematics (short sequences that contribute to the in-game plot), tips and strategies for achieving compliance objectives are provided to the player. The cinematics are developed in the demo mode of the game which does not involve player interaction. Consistent with the art, the premise of the demo mode is to motivate the player to understand and execute the game. The goal for the observational learning sequence is to correctly select required site specific object specifications. The strategy for achieving this goal is to identify information on such requirements as monitoring schedules and appropriate testing techniques and devices.

The second sequence of the game is the practice of procedural tasks for mandatory requirements. The exact action for the practice sequence is context-sensitive and involves interaction with objects that trigger grip and grasp hand maneuvers. User specific objects necessary to execute these tasks are located within the game space. The goal for the simulation sequence is to correctly practice the mandatory task/procedures that correlate to the user's specific requirements. The strategy for achieving this goal is to accurately and appropriately execute the practice to minimize adverse outcomes.

The third sequence of the instructional gaming system is experiential. Experiential game sequences are based on possibilities for learners to experience the consequences of performing both compliant and noncompliant procedures and appropriately responding to the consequences correlated with site specific components. The goal for the experiential scenarios is to correctly practice the mandatory or rule-based procedure and task requirements and to accurately, appropriately, and timely respond to the results and consequences of performances. The strategy will be to skillfully maintain resources and prevent any loss of human, environmental, property or third-party financial assets.

Loss ratings relative to mandatory or rule-based procedure/task requirements indicate the determination of losses assigned to noncompliant performance. For example, when a player performs untimely, inaccurate and/or inappropriate mandatory procedure/task requirements; warnings or probable non-compliance appears in the RMK. Noncompliance can result in fines, job loss, shut-downs and/or incarcerations with the consequence of professional and financial loss to the player. Additional resource losses can include human health, environmental resources, property damage, and equipment damage. Human loss due to unsafe or high risk practice, reflect harm and illness. Environmental loss reflects the contamination and of air, land and/or water resources. Property damage reflects structural losses due to destruction (fire or explosions). And equipment damage reflects losses due to repair or replacement.

To enhance motivation in the instructional game sequences, customization through site-specific object images can be corresponded to photographic and photorealistic images. Additionally, customized images can be correlated to images within reporting requirements to help maintain accuracy and customized images of schematic requirements or self-assigned requirements can be correlated to self-monitoring for just-in-time access.

To illustrate the present invention, underground storage tank (hereafter referred to as USTs) mandatory requirements (hereafter referred to as O&M task and procedures) is provided as an example to demonstrate the usefulness of the instructional game to transfer compliance knowledge to practice.

### BRIEF DESCRIPTION OF THE DRAWINGS

The accompanying drawings, which are incorporated in and constitute a part of this specification and, together with the description, explain the objects, advantages, and principles of the invention. In the drawings:

FIG. 1 is a flow chart which provides a high-level over view of the game engine and various embodiments of the present invention;

FIG. 2 is a diagram of an embodiment of a hardware and operating environment in conjunction with which the invention may be practiced;

FIG. 3 is an illustrations showing a view of the on screen control system for the instructional game and reporting sequences according to an exemplary embodiment of the present invention;

FIG. 4 illustrates the organization of generalized procedure and task requirements according to an exemplary embodiment of the present invention;

FIG. 5 represents a hierarchical method for accessing site-specific images for game and reporting customization according to an exemplary embodiment of the present invention;

FIG. 6A is an illustration showing an exemplary site facility within a 3-D game space, with player site specific object selections, before customization according to an exemplary embodiment of the present invention;

FIG. 6B is an illustration showing an exemplary site facility within a 3-D game space, with player site specific object selections, after customization according to an exemplary embodiment of the present invention;

FIG. 7A is an illustration showing an alternative customization state where a site facility is customized with user-specific images imported by the player according to an exemplary embodiment of the present invention;

FIG. 7B is an illustration of an alternative state where the object images imported by the player are further customized according to an exemplary embodiment of the present invention;

FIG. 8 is a flow chart process for demonstrating mandatory or rule-based procedure and task requirements according to an exemplary embodiment of the present invention;

FIG. 9A are illustrations showing a state where the player object is interacting with the game control system within the demonstration embodiment according to one exemplary embodiment of the present invention;

FIG. 9B are illustrations showing a state where the player object is interacting with the game control system within the demonstration embodiment according to a second exemplary embodiment of the present invention;

FIG. 9C are illustrations showing a state where the player object is interacting with the game control system within the demonstration embodiment according to a third exemplary embodiment of the present invention;

FIG. 10A is the first of two portions of a method for practicing mandatory or rule-based procedure and task requirements according to an exemplary embodiment of the present invention;

FIG. 10B is a continuation of FIG. 10A;

FIG. 11 is an illustration of a 3-D game scene for simulating a task procedure according to an exemplary embodiment of the present invention;

FIG. 12 is an illustration showing a field map of specific task maneuvers for compliant performance in real-time practice and/or real time or self-monitoring according to the present invention;

FIG. 13 is an illustration showing a state where a player object is practicing a simulated task requirement according to an exemplary embodiment of the present invention;

FIG. 14 illustrates an assessment of the player's performance shown in FIG. 13 after practicing a simulated task according to an exemplary embodiment of the present invention;

FIG. 15A is the first of two portions of a flow chart for experiencing operations and maintenance procedures and tasks according to an exemplary embodiment of the present invention;

FIG. 15B is a continuation of FIG. 15A;

FIG. 16 is an illustration a 3-D game scene for experiencing mandatory or rule-based procedure and task requirements according to an exemplary embodiment of the present invention;

FIG. 17 is an illustration showing a state in which a player object is experiencing and responding to the consequences of a set of mandatory or rule-based procedure and task requirements according to an exemplary embodiment of the present invention;

FIG. 18 is an illustration showing the player object and 3-D game space in FIG. 17 through an overlay of the field map of FIG. 12 identifying the required tasks, responsible parties and incidents that may have occurred;

FIG. 19 is an illustration showing a character object and the consequences from a noncompliant performance within a 3-D game space according to an exemplary embodiment of the present invention;

FIG. 20 illustrates specific embodiment details of a hardware and operating environment, in which the reporting application of an exemplary embodiment of the present invention may be practiced;

FIG. 21 is a flow chart process for documenting mandatory or rule-based reporting procedure and task requirements according to an exemplary embodiment of the present invention;

FIG. 22 is an illustration showing the incorporation of images and animation within a mandatory form to support reporting requirements according to an exemplary embodiment of the present invention;

FIG. 23 is a flow chart process for documenting self-monitoring procedure and task requirements according to an exemplary embodiment of the present invention;

FIG. 24A is an illustration of the incorporation of field maps and animation to support self-monitoring on a mobile device according to one exemplary embodiment of the present invention;

FIG. 24B is an illustration of the incorporation of field maps and animation to support self-monitoring on a mobile device according to a second exemplary embodiment of the present invention;

FIG. 24C is an illustration of the incorporation of field maps and animation to support self-monitoring on a mobile device according to a third exemplary embodiment of the present invention;

FIG. 24D is an illustration of the incorporation of field maps and animation to support self-monitoring on a mobile device according to a fourth exemplary embodiment of the present invention;

FIG. 25A is an illustration of one exemplary embodiment of a temporary dermal communication device and operating environment in conjunction with which the instructional game of this invention may be practiced;

FIG. 25B is an illustration of a second exemplary embodiment of a temporary dermal communication device and operating environment in conjunction with which the instructional game of this invention may be practiced;

FIG. 25C is an illustration of a third exemplary embodiment of a temporary dermal communication device and operating environment in conjunction with which the instructional game of this invention may be practiced; and

FIG. 26 is a method for describing a method for a temporary dermal communication device according to an exemplary embodiment of the present invention.

### DETAILED DESCRIPTION OF THE PRESENT INVENTION

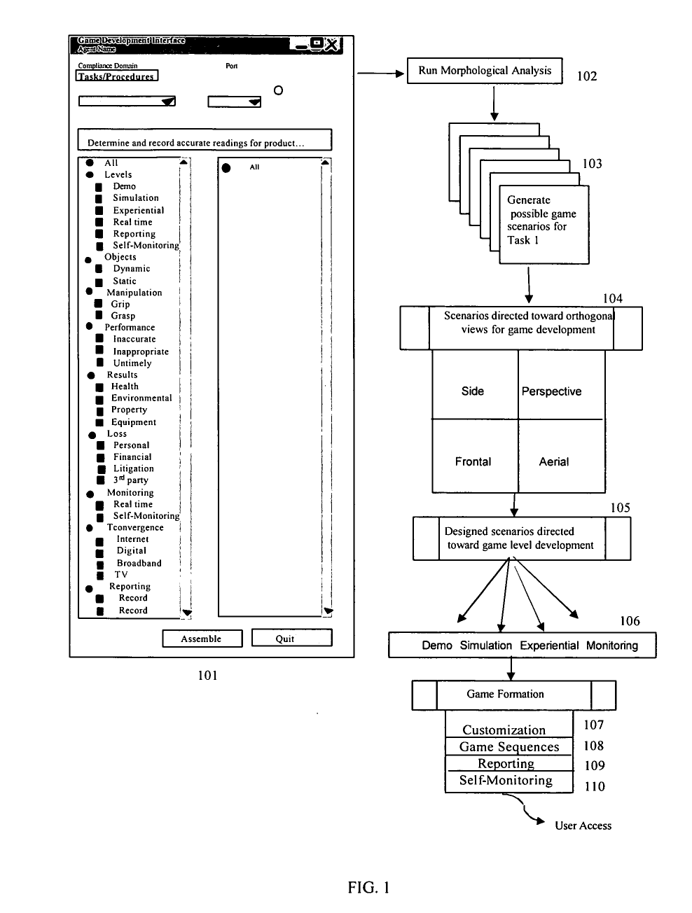

Referring to FIG. 1, there is shown at 100, a flow chart which provides a high-level overview of a game engine in accordance with an exemplary embodiment of the present invention. In step 101, the architecture of the game is developed around a morphological field of parameters that can influence compliance adherence. Field parameters include: standards, regulations, self-assigned parameters are indexed to type of cognitive construct states correlated to game levels, object, type of manipulation, sequence of performance, type of result, type of consequence, type of resource loss, recordkeeping, self-monitoring and technology convergence. In step 102, a morphological analysis is run generating 18,432 scenarios for the illustrated task procedure, “Determine and record accurate readings for product and water in the tank before product delivery.” To begin the graphic development for respective game levels in step 104, the scenarios are then processed respective game levels based on orthogonal views to include: perspective, aerial, frontal and side. In step 105, graphically prepared, animated and sound enhanced scenarios are assembled into game levels to include Demo, Simulation, Experiential and Monitoring. At 106, a formatted game is presented to user.

A customization level 107 enables access to site-specific objects through a predetermined lexicon, digital image, or sensor signal to create familiarization throughout the game sequences and is provided in the reporting process. Instructional gaming sequences 108, for adherence to conformity, can include demonstrations, practice and experiential methods to achieve a systematic approach to enhance compliance knowledge and transfer it to practice. Reporting 109, reduces ambiguity and maximizes the accuracy of reporting documentation and support field map representation. Self-Monitoring assessment 110 provides convenient access and near-real-time information access through the display of compliant path schematics.

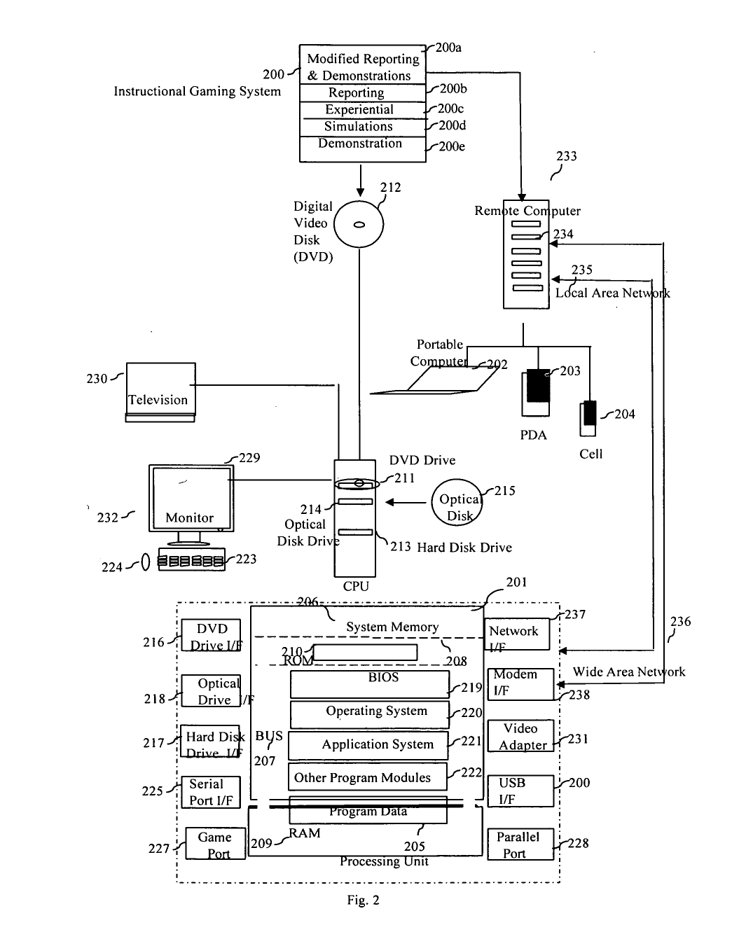

Referring now to FIG. 2, there is shown a diagram of an exemplary embodiment of the present invention. The embodiments with which the invention can be practiced can be a conventional computer or any other type of computer such as a server for embodiments 200b-200e; or for specific executable processor application(s), embodiment 200a can also be accessed by a portable computer 202 personal digital assistant (PDA) 203, or a cellular telephone 204. Additionally, embodiment 200c can reside on a portable video game device (not shown). Such a processing unit 201 typically includes one or more processing units as its processor, and a computer-readable medium such as a memory. The processing unit 201 can also include a communications device such as a network adapter or a modem, so that it is able to communicatively couple to other computers or servers.

As illustrated in FIG. 2, the hardware and operating environment includes a general purpose processing unit 201, a system memory 206, and a system bus 207. The system memory can include read only memory (ROM) 208 and random access memory (RAM) 209. A basic input/output system (BIOS) 210, containing the basic routines that help to transfer information between elements within the processing unit 201, such as during start-up, may be stored in ROM 208.

The processing unit 201 further includes a digital video disk (DVD) drive 211 for reading from a removable DVD 212, a hard disk drive 213 for reading from and writing to a hard disk, not shown, and an optical disk drive 214 for reading from or writing to a removable optical disk 215 such as a CD ROM or other optical media. The DVD drive, hard disk drive 213 and optical disk drive 214 couple with a DVD drive interface, a hard disk drive interface 217 and an optical disk drive interface 218, respectively. A number of program modules can be stored on the DVD 212, hard disk, ROM 208, or RAM 209, including an operating system 219, one or more application programs 220, other program modules 221, and program data 222. A plug-in containing a search engine for the present invention can be resident on any one of a number of these computer-readable media.

A user may enter commands and information into the processing unit 201 through input devices such as a keyboard 223 and pointing device 224. Other input devices (not shown) can include a stylus, satellite dish, scanner, game device or the like. These other input devices are often connected to the processing unit 201 through a serial port interface 225 that is coupled to the system bus 207, but can be connected by other interfaces, such as a parallel port 226, game port 227, or a universal serial bus (USB) 228. A monitor 229 or other type of display device (television 230) can also be connected to the system bus 207 via an interface, such as a video adapter 231. The monitor 229 can display a graphical user interface for the user. In addition, the computer will include speakers 232 and printer (not shown) peripheral output devices to support embodiments of the invention.

The processing unit 201 may operate in a networked environment using logical connections to one or more remote computers or servers, such as remote computer 233. These logical connections are achieved by a communication device coupled to or a part of the processing unit 201; the invention is not limited to a particular type of communications device. The remote computer 233 can be another computer, a server, a router, a network PC, or other common network node, and typically includes many or all of the elements described above relative to the processing unit 201. The logical connections depicted in FIG. 2 include a Local Area Network (LAN) 235 and a Wide Area Network (WAN) 236.

When used in a LAN-networking environment, the processing unit 201 is connected to the LAN 51 through a network interface or adapter 237, which is one type of communications device. When used in a WAN-networking environment, the processing unit 201, typically includes a modem 238, a type of communications device, or any other type of communications device, i.e. a wireless transceiver, for establishing communications over the wide area network 236, such as the Internet; the invention is not so limited. The modem 238, which may be internal or external, is connected to the system bus 207 via the serial port interface 225. In a networked environment, program modules depicted relative to the processing unit 201, or portions thereof, can be stored in the remote memory storage device 234 of the remote computer or server 233. The received data can thus be received via a wired and/or wireless communications network, via, for example, digital devices. It is appreciated that the network connections shown are exemplary and other means of and communications devices for establishing a communications link between the computers may be used.

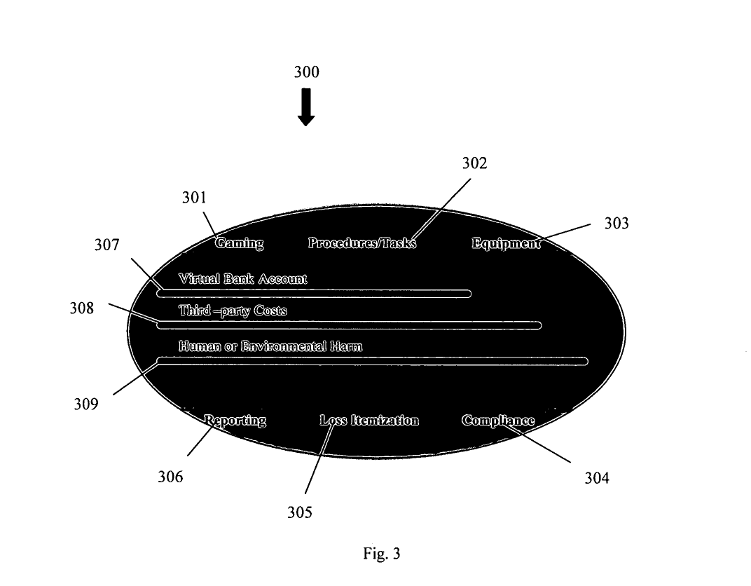

Referring now to FIG. 3, there is shown at 300 an illustration of the on screen control system for the instructional game and reporting sequences according to an exemplary embodiment of the present invention. The illustration is of an RMK that depicts the menu controls of the gaming application. These categories include: Game Sequences 301, Procedures and Tasks 302, Site-Specific Objects 303, Reporting 306, Loss Itemization 305, and Compliance Status 304. The RMK in the present invention provides a method of accessing all levels through the game as well as providing a continuous summary of virtual resources. FIG. 3 illustrates the virtual resources that are lost as the result of noncompliant performance within the gaming system. The top line is representative of personal financial loss 307. The middle line is representative of third-party financial loss 308, while the last line is representative of loss due to human or environmental harm 309. Noncompliant performance by the player results in a reduction of line length to the left; whereas compliant performance shows no movement.

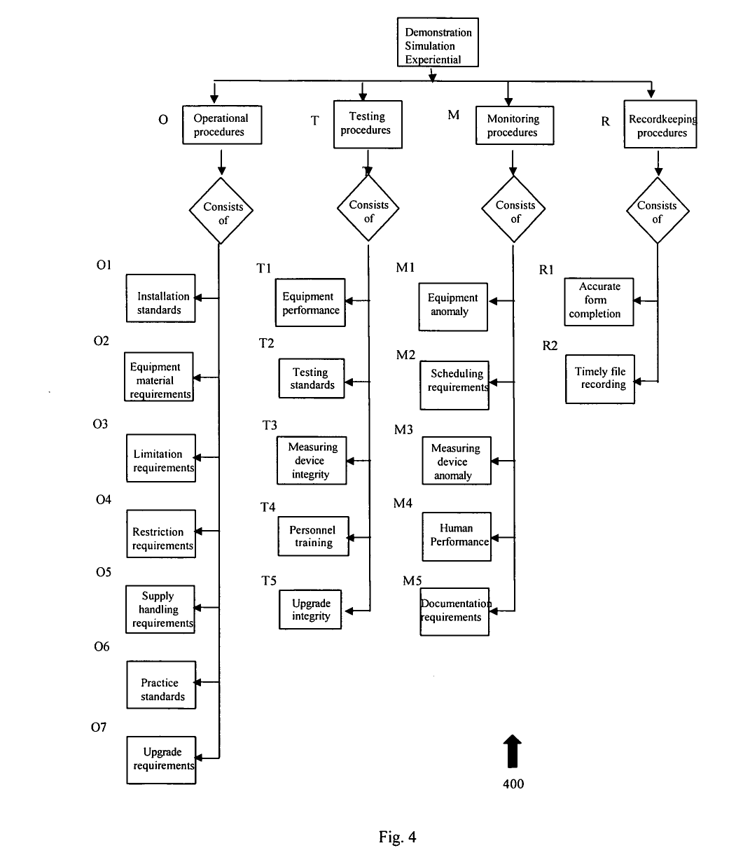

FIG. 4 illustrates the organization of a section of mandatory procedures and tasks according to the present invention. As illustrated in FIG. 4, game procedures are abbreviated as the following respective symbols in the figure: operations “O”, testing “T”, monitoring “M”, and recordkeeping “R”. Relevant tasks can include: installation standards “O1”, material requirements “O2”, limitation requirements “O3”, restriction requirements “O4”, supply handling requirements “O5”, practice standards “O6”, and upgrade requirements “O7”. Respective testing tasks can include: object (i.e. equipment) performance “T1”, testing standards “T2”, testing device integrity “T3”, testing of personnel “T4” and upgrade integrity “T5”. Relevant monitoring tasks can include: object/device anomaly “M1”, scheduled requirements “M2”, measuring device equipment anomaly “M3”, accurate human performance “M4” and documentation requirements “M5”. And particular recordkeeping tasks can include: accurate form completion “R1” and timely file recording “R2”.

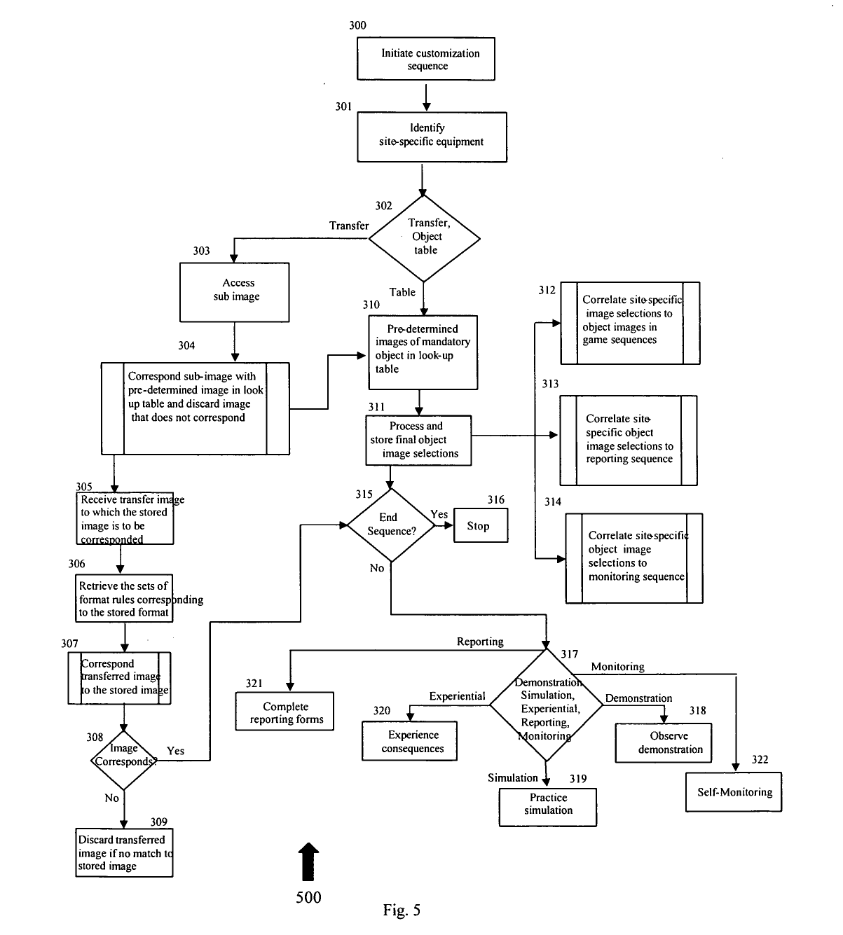

Referring now to FIG. 5, there is shown at 500 a hierarchical method for accessing site-specific information for customizing the game sequences and/or monitoring a player's real-time practice performance. The sequence is initiated at 300, with an illustration of a photorealistic map, site facility and player identifiers located within the game space. To customize the game, record keeping and self monitoring sequences, the player is to select object requirements in step 303 that apply to the player's location, facility or person, by interacting with the identifiers in the game field. In step 304 the player imports an image file into the object field of the RMK. For exemplary a purposes, the player has imported an image file from his personal computer via a digital camera.

In step 305, this image is retrieved and a set of format rules corresponding to the stored format is retrieved in step 306. The resulting sub-image of the player's site-specific image (equipment) will then be processed to predetermined parameters of an equivalent sub-image of the same object image (equipment) retrieved from a conversion library of equivalent object images in step 307. In step 308, an analysis is made as to whether the transferred image corresponds to the stored equivalent image.

If the transferred image does not correspond to the stored image, the transferred image is discarded, does not appear within the RMK and the player is notified to try again in step 309. Additional object images (not within viewing site) are also available to the player from a predetermined lexicon and object image resource table in step 310. Access to the images can be retrieved from the object menu within the RMK.

After selection of site-specific object images from either of these resources, the player is prompted in step 311 to store all object images for processing. If the player's image is determined to correspond to the equivalent stored object image, a correlation is made between the matched predetermined equivalent sub-image and stored equipment image game feature in step 312, the object image reporting feature in step 313 and the object image self monitoring feature in step 314. When the player is satisfied with object selections the player is prompted in step 306 to store the final selections.

Further customization can be conducted at this time regarding pre-assigned monitoring type, procedure/task scheduling and player/user notification preferences. Monitoring practice or advisory mode is conducted in real-time. Procedure/task selection is correlated with required date, time and quantity measures as applicable and player is provided the option of notification preferences which can include but is not limited to image, sound or communication processes. When monitoring in real-time, the player's notification preferences can be corresponded to digital image retrieval. For example, the player imports an image file from images which can include a digital, laser, radio microwave, (see bar code game) an analysis is made as to whether the transferred image corresponds to the stored equivalent image and pre-assigned quantity parameters. If parameters match pre-assigned restrictions player may wish to be notified. If on the other hand parameters are exceeded or are about to be exceeded, player can be provided with communication that serves as an intermediate intervention to the pre-assigned parameter restriction.

At the completion of the customization process, all of the player's site specific equipment selections will appear within the virtual site facility which includes: E1, a fiberglass tank, E2, overfill alarm device and probe, E3, line leak detection, E4, cathodic protection E5, Stage II vapor recovery and E5, an alarm system located outside the facility.

The player is prompted in step 314 to end the customization sequence by proceeding to step 315 to stop. If the player wants to continue with the Instructional gaming or Reporting sequences in step 316, the player can go to the demonstration, practice simulation and experiential sequences in steps 317, 318, or 319 respectively or the record keeping or reporting sequence in 320 or 321.

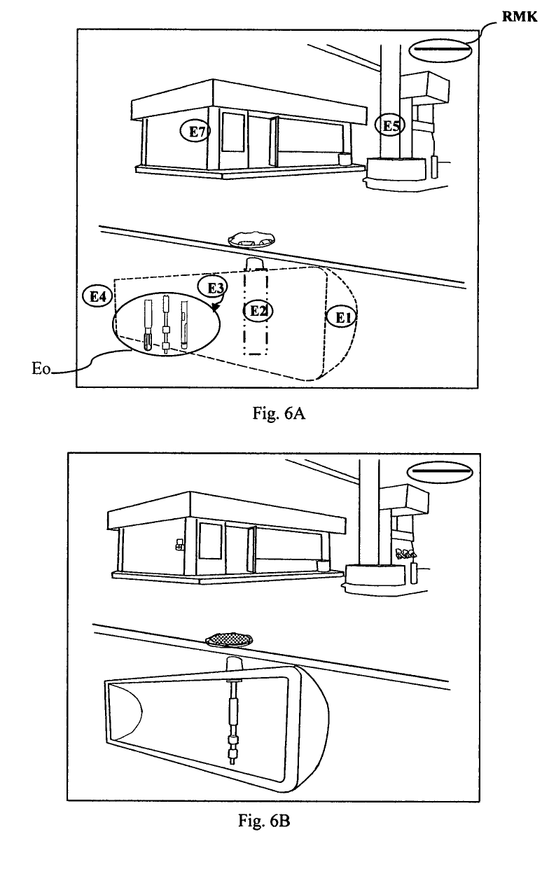

Referring now to FIG. 6A, there is shown an illustration showing a state where a site facility within a 3-D game space is customized with player specific object selections (specific to this illustration, equipment or components) according to an exemplary embodiment of the present invention. A 3-D terminal station for gasoline is presented with object (equipment) identifiers within the game space before customization. Equipment object identifiers (abbreviated as symbol “E” and a sequential number in the figure respectively) can include: E1, type of tank, E2, type of overfill, E3, type of leak detection, E4, type of corrosion protection E5, type of vapor recovery, E5, alarm system. When the player interacts with the identifier, the identifier expands within the game space to provide the player with appropriate selections (stored within a pre-determined lexicon) that meet regulatory standards. In one exemplary embodiment, to view overfill protection equipment (abbreviated as a symbol “Eo” in the figure), three devices are permitted, overfill alarm systems, shut-off devices or ball float valves. By accessing the overfill device of choice utilized at the player's facility, the selected equipment component is placed within the tank.

Referring now to FIG. 6B, there is shown an illustration of an example of a customized facility as it will appear in the RMK.

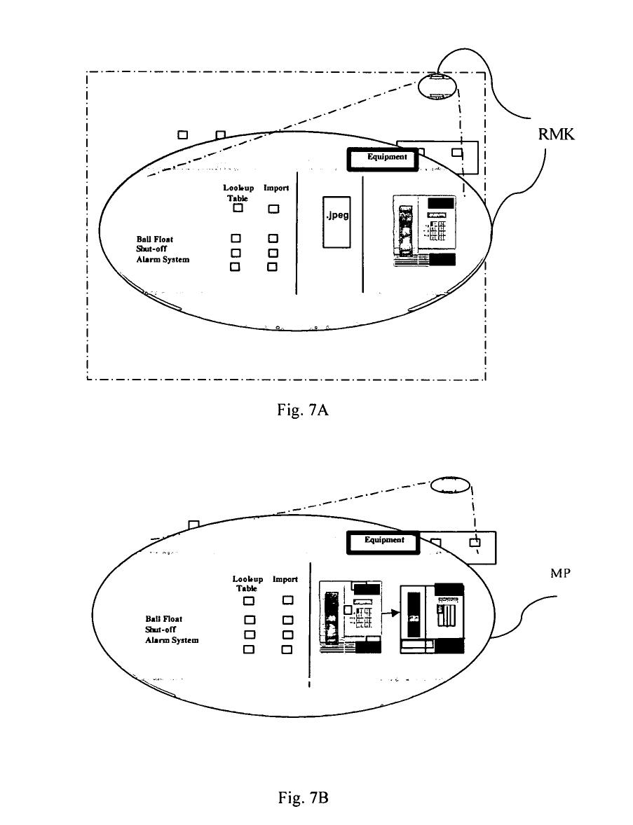

Referring now to FIG. 7A, there is shown an illustration of an alternative state where a site facility is customized with object images imported by the player. In one embodiment the player is given the option in step 302 to access images of site specific objects that have been identified (transferred from a digital camera device) in step 303.

Referring now to FIG. 7B, there is shown an illustration of an alternative state where the object images imported by the player are further customized.

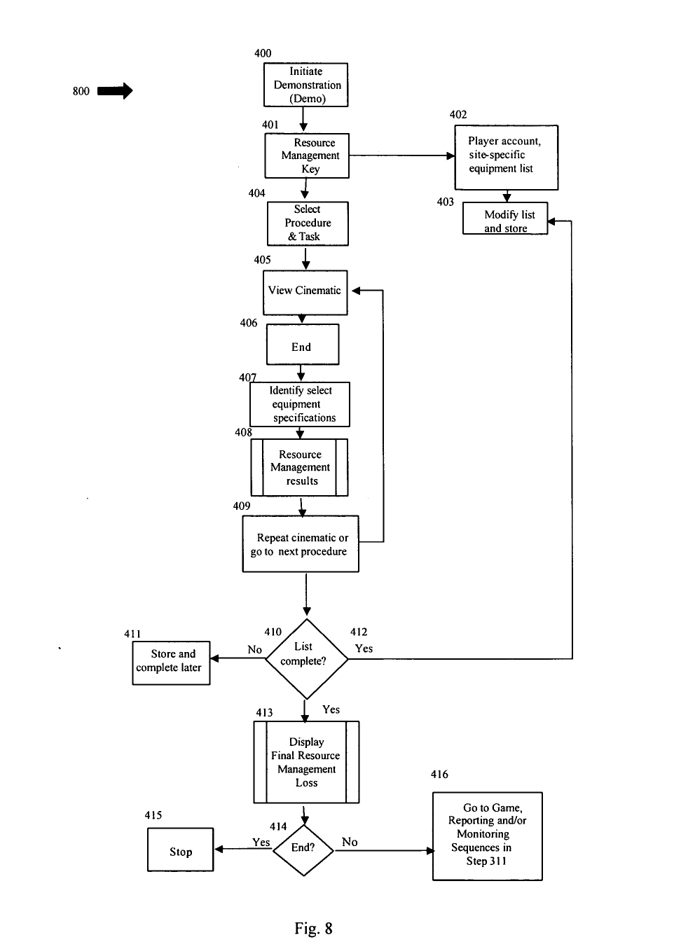

Referring now to FIG. 8, there is shown at 800 a flow chart process for demonstrating operations and maintenance procedures and tasks according to the present invention. The Demonstration sequence is initiated in step 400 with the appearance of the terminal station in the RMK illustrated in FIG. 6B. In step 404, the player is prompted to choose the demonstration sequences from the gaming field within the RMK as illustrated in FIG. 3. Here the player can view cinematic presentations of required procedures and tasks.

In step 405, a cinematic will present the mandatory requirements for the specific process identified by the player.

At the completion of the Release Detection cinematic in step 406, the player is prompted to recall and identify the step-by-step tasks of the procedure in step 407. For example, the following procedures are required to ensure complaint performance with the inventory control portion of the ICTTT. These procedures include: A. You must use this combination up to 10 years following installation of a new tank; B. For inventory control, you must take inventory and dispenser readings and record numbers daily when product is added or removed; C. Reconcile deliveries with delivery receipts by taking inventory readings before and after each delivery; D. You must reconcile these numbers at least once a month and record your results. No losses are reflected in the RMK results in step 408 and probable compliance is determined in the assessment of the inventory control portion of the testing.

If on the other hand, the player's specification selections had been incorrect, probable noncompliance would have been determined. Specifications that do not meet requirements immediately prompt the player to view the RMK to review the results of the previous specification selection. In step 409, the player can repeat the viewing of the cinematic or go to the knowledge assessment for the next procedure.

The player then proceeds to step 410 to the completed data request option. If the data requests are not complete, the player is prompted in step 411 to store player's specifications and complete the request at a later time. If the data request is complete, the player is prompted to save, store to RMK in step 412 and then review the final resource loss results in step 413 where individual monetary deductions (for probable losses due to fines) are displayed.

The player is prompted in step 414 to end the demonstration sequence which will stop in step 415. If the player does not want to end the sequence, the player can proceed to the game, reporting, and/or monitoring sequence in step 416.

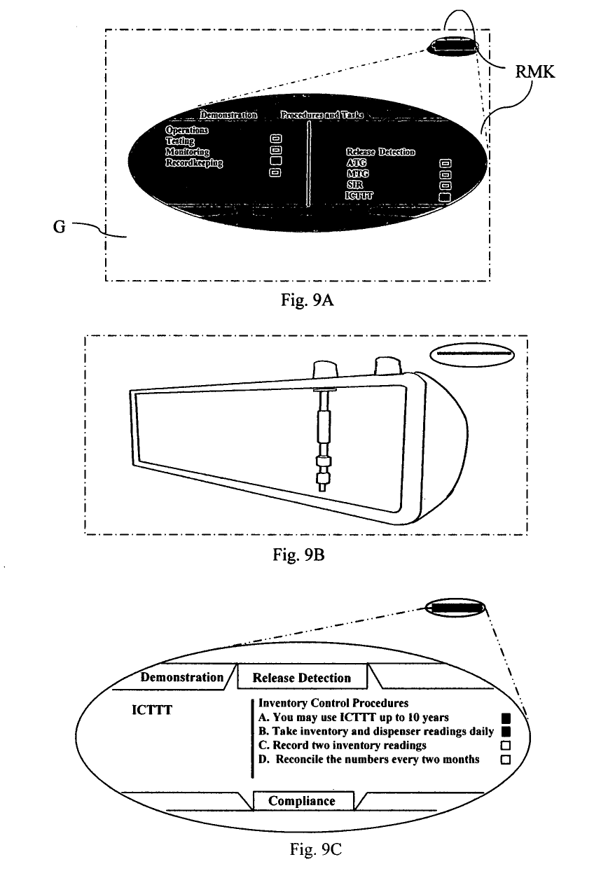

Referring now to FIG. 9A, there is shown an illustration of the on screen control system before and after a demonstration cinematic within one embodiment of the present invention. In one exemplary embodiment, the player interacts with the Procedure/Task field in the RMK to choose Operational procedures and the relative tasks of Release Detection. For example, monitoring for release detection can include: Ground water monitoring, vapor monitoring of secondary containment, Inventory control/tank tightness testing (ICTTT) and or Manual Tank Gauge (MTG).

Referring now to FIG. 9B, there is shown an illustration of a 3-D game space within the demonstration sequence whereby the player's site specific object (equipment) selections (to include a fiberglass tank and tank probe) are shown during the explanation of the inventory control procedure.

Referring now to FIG. 9C, there is shown an illustration of a reduction in the line representative of personal financial resources due to the noncompliance. In one alternative embodiment, if the player has identified the two correct tasks conducted at the player's site, the result is no movement in the line representative of personal financial resources.

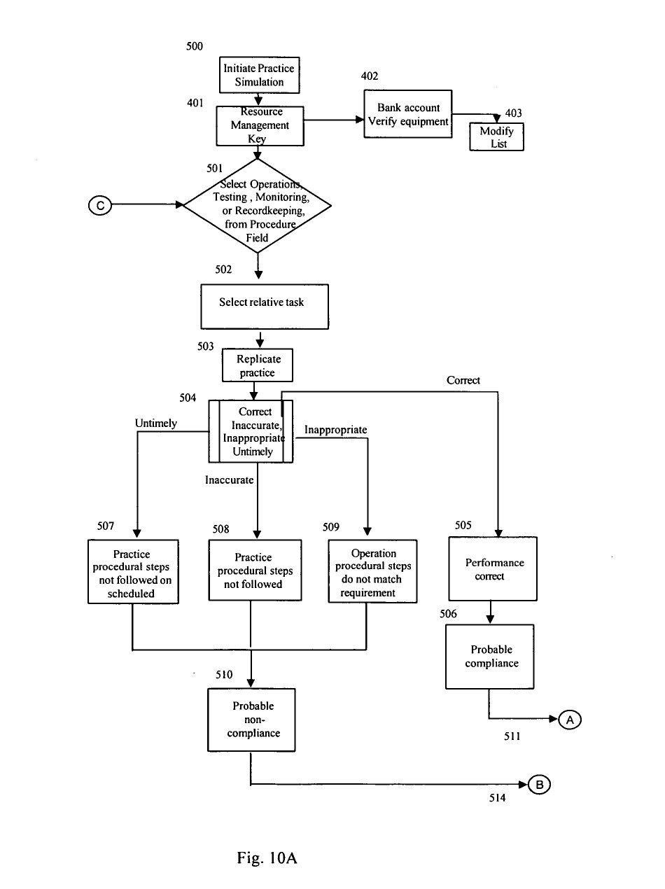

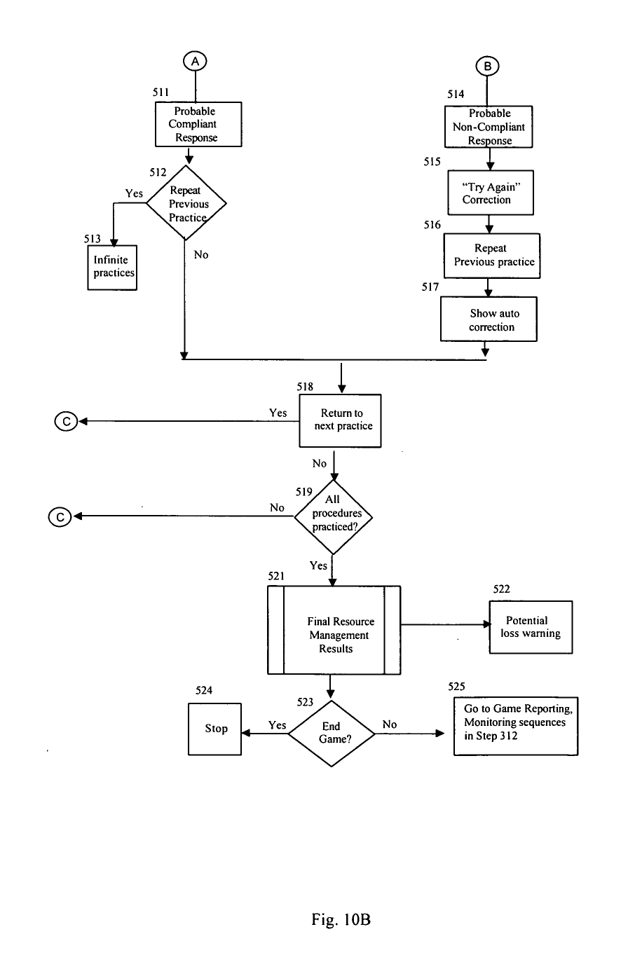

Referring now to FIG. 10A and FIG. 10B, there is shown a method for practicing required procedures and tasks according to the present invention. The method starts on FIG. 10A and ends on FIG. 10B. The method begins at 500 by displaying the player's virtual site facility in the RMK as illustrated in FIG. 6A. If any changes are necessary, the player can proceed to add or change equipment choices in step 403 that will be incorporated in the practice simulation replications. The player is then prompted in step 501 to select a category of O&M equipment practices from the Procedure/Task categories listed in the RMK as depicted in FIG. 3. At 502, the player selects the relative task. At 503, the practice of the required tasks is executed and fixed equipment/component objects in the virtual world are activated.

In step 504 the player's performance is processed and determined to be correct, inaccurate, inappropriate, or untimely. Correct performances in step 505 meet all the mandatory requirements and are deemed in probable compliance in step 506. Inaccurate, inappropriate or untimely performances in steps 507, 508 and 509 respectively, are determined non-compliant in step 510 due to procedural steps not being followed.

Probable non-compliant responses can be corrected in step 514. In step 515 the player can try and correct the previous performance and is given up to two “tries” in step 516 to accomplish the correction. After two “tries” an automatic correction of the procedure is displayed to the player in step 517. If on the other hand the practice was determined correct, in step 511, the player can repeat the correct practice indefinitely in step 512.

In step 518, the player is queried regarding the completion of the specific practice sequence and is given the option of returning to the next practice replication in step 501 or reviewing the resource loss results. Warnings in step 521, regarding monetary deductions for probable losses due to fines are displayed in step 522.

To conclude the simulation the player is prompted in step 523 to end the practice sequence which will stop in step 524. If the player does not want to end the sequence, the player can proceed to either the Gaming sequences or Reporting sequence in step 525.

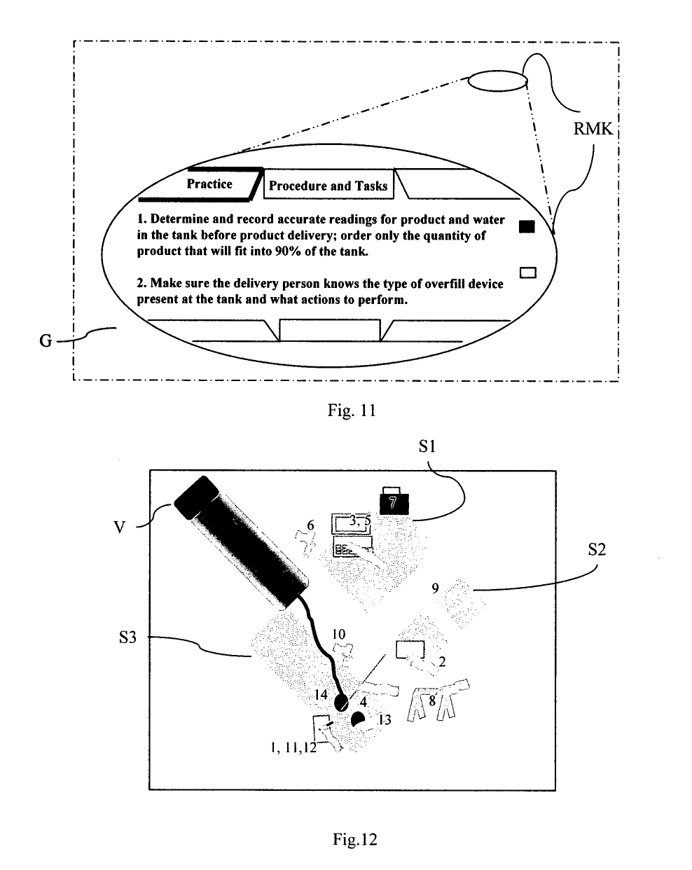

Referring now to FIG. 11, there is shown an illustration of a 3-D game scene for simulating a task procedure according to an embodiment of the present invention. For example, in FIG. 11 the player has selected to practice the step-by step tasks required for a product delivery. The procedural tasks that will involve a simulated task maneuver (abbreviated by a sequential number from 1-14 in the figures) can include:

Determine and record accurate readings for product and water in the tank before product delivery.

Make sure the delivery person knows the type of overfill device present at the tank and what actions to perform if it activates. For example, post a sign where the delivery person will see it.

Review and understand the spill response procedures.

Make sure the spill bucket is empty, clean, and will contain spills.

Have an accurate tank capacity chart available for the delivery person.

Have a person responsible for monitoring the delivery available each time tanks are being filled; the delivery person makes all hook-ups.

Make sure spill response supplies are available in case a spill or overfill occurs.

Make sure there are safety barriers around the delivery area.

Make sure there is adequate lighting around the delivery area.

Have a person available to monitor the disconnection of hook-ups following delivery; the delivery person disconnects the hook-ups.

Determine and record accurate readings for product and water in the tank after delivery.

Verify the amount of product received.

Make sure fill ports are properly secured.

Make sure the spill bucket is free of product and clean up any small spills.

Each task is represented within the game space as a hand maneuver, interacting with testing or monitoring equipment specifically utilized for the particular task. For example, to complete the recording of accurate readings for product and water in the tank before product delivery; as required for procedural task one listed above in FIG. 11, the player could use either pen or paper or a computer device to document the readings.

Referring now to FIG. 12, there is shown an illustration of a state where a player is practicing a simulated task requirement according to an exemplary embodiment of the present invention. In one exemplary embodiment, a field map of specific task maneuvers for compliant performance in real-time practice and/or real time or self-monitoring is used by a player. As illustrated in FIG. 12 of the 3-D simulation, the game space shows the practice of the recording of accurate readings for product and water in the tank before product delivery for Task One, previously described in FIG. 11.

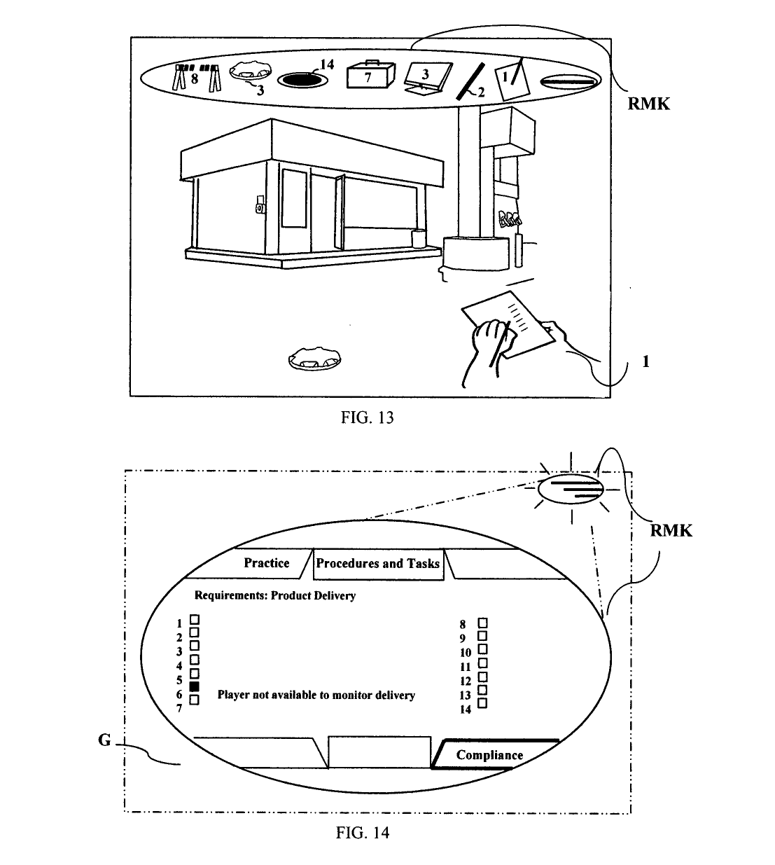

Referring now to FIG. 13, there is shown an illustration of a field map of iconic representations of the task maneuvers required for compliant performance according to the present invention. To perform the tasks, the player moves an interface device over one of the tasks (located along the top of the product delivery game space within the RMK. A virtual hand then maneuvers the object in place. For example, Product delivery task maneuver “1” appears in the lower right hand corner of the game scene to be used by the player to record accurate readings for product and water in the tank before product delivery.

Referring now to FIG. 14, there is shown an illustration of an assessment of the player's performance shown in FIG. 13 after practicing a simulated task according to the present invention. As illustrated in FIG. 14, the player's inaccurate performance of a task during the simulated practice of product delivery is reflected by a warning of probable non-compliance through the blinking of the RMK.

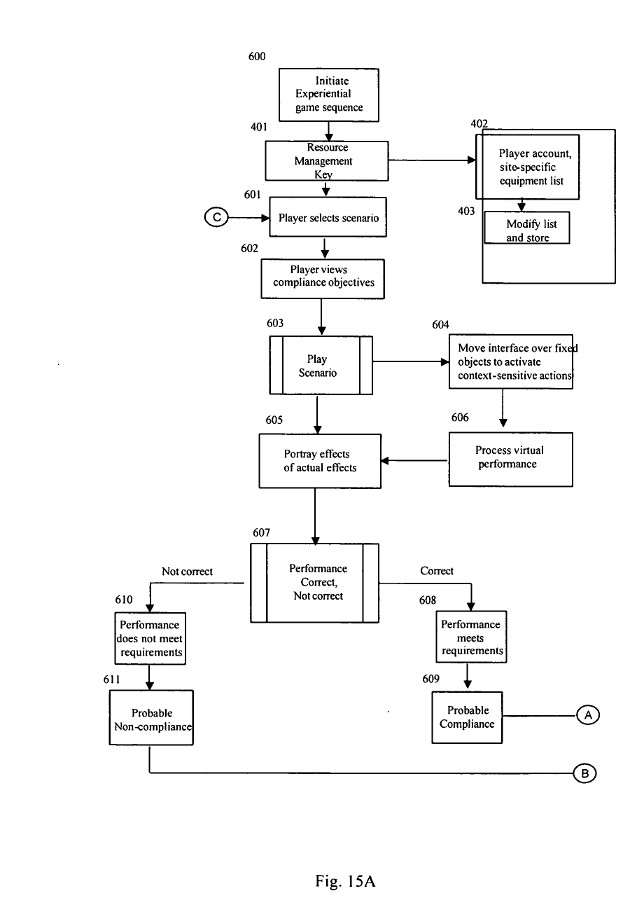

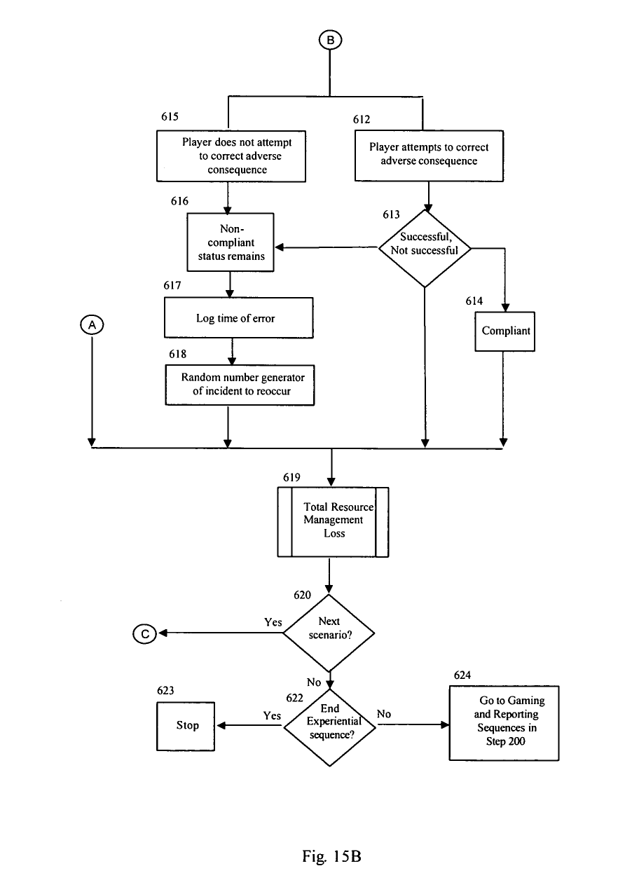

Referring now to FIG. 15A and FIG. 15B, in FIG. 15A there is shown a first of two portions of a method for experiencing the compliant and noncompliant consequences of procedures and tasks according to the present invention. FIG. 15B is the continuation of 15A. The method begins at 600, where an experiential game sequence is initiated. The method proceeds to 401.

The player is prompted to review the RMK in steps 401-403 to review monetary resources in the player's bank account, verify and modify the previous site specific equipment and specification selections or move directly to the scenarios. Scenarios in the experiential sequence are automatically executed to correlate to the practices depending upon the player's previous selections in the Simulation sequence.

In steps 601 and 602 the player is presented with a scenario and given objectives to accomplish the step-by-step task requirements based on supply handling procedural tasks previously illustrated in FIG. 11 and FIG. 12.

In step 603, the player initiates the scenario. In addition to interface commands that continue to activate fixed objects in step 604, the combinations also now trigger walking, running, climbing and jumping ranges of motion for the player and other characters in step 605. The player's performance of tasks, interaction and responses to objects, characters, performance and consequences, are processed in step 606 to portray actual effects.

After the completion of the scenario by the player, the player's performance is determined to be correct or incorrect in step 607. This determination is based on predetermined rules (e.g. did the player accurately perform the fourteen task requirements and did the player appropriately respond to the character and incident interactions within the scenario?). If the player has correctly responded to the scenario by performing and responding to all requirements correctly in step 608, the assessment in step 609 would be that the player was in compliance. The player is would then be prompted to review the RMK for final losses in step 620.

For exemplary purposes, the player has inaccurately performed and responded to a task within the product delivery scenario in step 610 and is assessed in step 611 to not be in compliance.

After prompted to review the inadequacies of the previous performances in step 612, the player can either correct or not correct the adverse consequences. If the player attempts to correct the consequences in step 613 (by replaying the sequence) and performs the tasks and responses correctly in step 614, the player is determined to be compliant in step 615. The player is prompted to review the RMK for final losses in step 620. If the player does not attempt to correct the consequences in step 616 the player remains noncompliant in step 617 and the log time of the error is initiated in step 618 causing a random number generation of the incident to reoccur. In step 619, the player can proceed to review the final resource loss results where individual monetary deductions for probable losses due to fines are displayed.

In step 620, the player is queried regarding the completion of all experiential scenarios and is presented with the option of moving to the next scenario in step 621. The player can then proceed to step 622 to end the demonstration sequence which will stop in step 623. If the player does not want to end the sequence, the player can proceed to previous game, reporting or monitoring sequences in step 624.

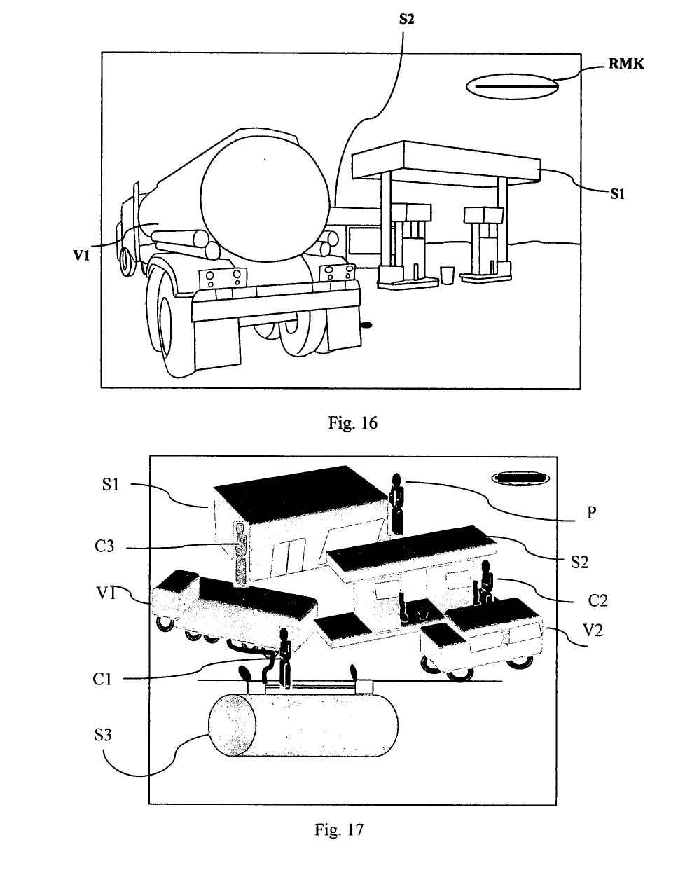

Referring now to FIG. 16, there is shown an illustration of a 3-D game scene for experiencing operations and maintenance procedures and tasks according to a product delivery scenario. In one exemplary embodiment, structural objects and transportation vehicles are abbreviated by the following symbols respectively, “S1” for the station, “S2”, for the dispensers, “S3” for the storage tank, “V1” for the gasoline delivery truck and “V2” for a customer vehicle.

Referring now to FIG. 17, there is shown an illustration of a state where a player object is experiencing tasks involved within the product delivery scenario involving other characters. In one exemplary embodiment, structural objects and transportation vehicles are abbreviated “C1” for the delivery person, “C2” for the customer and “P” for the player. Experiential scenarios expand on simulation practices to allow the player to walk around in the virtual world to perform the procedural tasks.

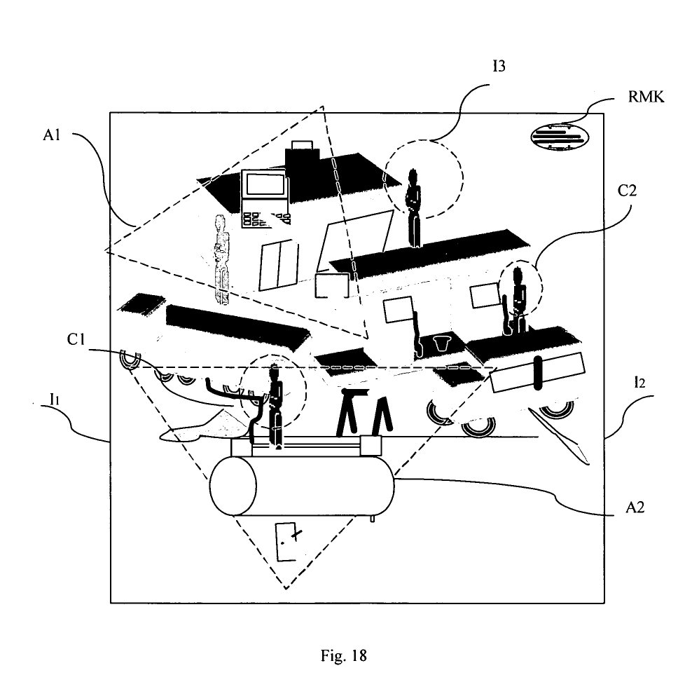

Referring now to FIG. 18, there is shown an illustration of the 3-D game space in FIG. 17 through an overlay of the field map of FIG. 12 identifying the required tasks, incidents that may have occurred and the responsible parties. In one exemplary embodiment, each of the 14 task procedures, represented by iconic representation, occur within 2 action zones (abbreviated with symbols “A1” and “A2” respectively within the figure). In addition, to the accurate performance of the required tasks, the player must also have appropriately interacted and responded to characters C1 and C2, and any incidents (abbreviated with symbols “I1” and “I2” respectively within the figure) that may have occurred. In one exemplary embodiment, due to the product releases, red circles are used to identify the responsible characters.

The primary responsibility for the release falls to the player in that player was required to oversee or assign the responsibility for someone to oversee the product delivery. As this was not done, FIG. 18 illustrates product losses by both characters C1 and C2.

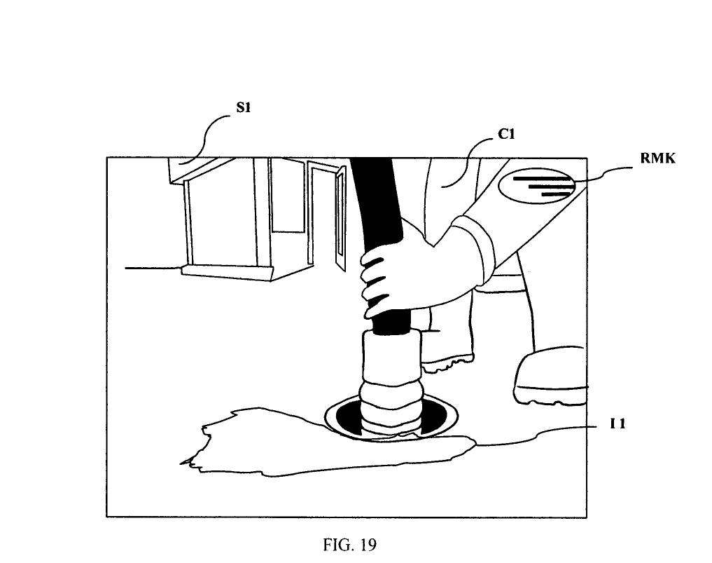

Referring now to FIG. 19, there is shown an illustration of a zoom in illustration on character object C1 and the consequences from the player's noncompliant performance by the delivery person within the product delivery scenario. In one exemplary embodiment, adverse effects from an overfill by the delivery person have resulted in a release of product onto the ground. The RMK reflects a recession in the bar length to the left which denotes financial losses to the player. Additional costs are also estimated to incur as the result of product clean-up from both the delivery personnel and the customer.

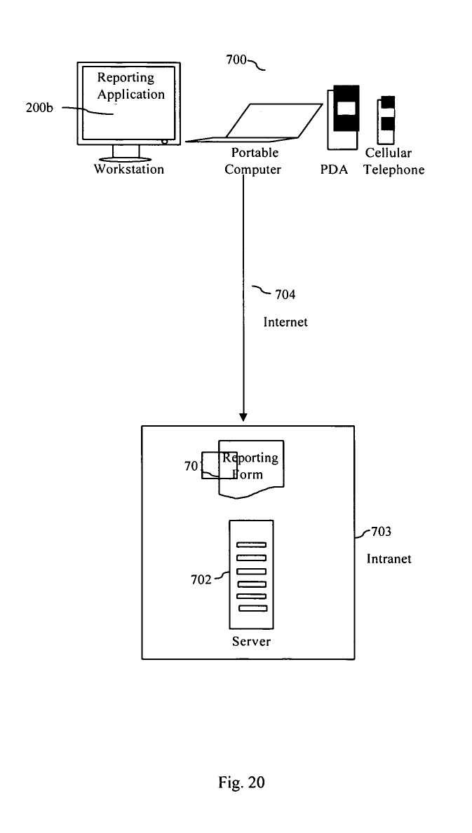

Referring now to FIG. 20, there is shown an illustration of a hardware and operating environment, in which the reporting application of the present invention may be practiced. In one exemplary embodiment, the player (hereafter referred to as user) can access reporting forms 701 executed on a web server 702 connected to the Intranet 703 or the Internet 704 from communication devices 700 through internet, telephone, television or wireless access. Specifically, a plug in containing a search engine for the reporting application 200b of the present invention can be resident on any one or number of devices 700 illustrated.

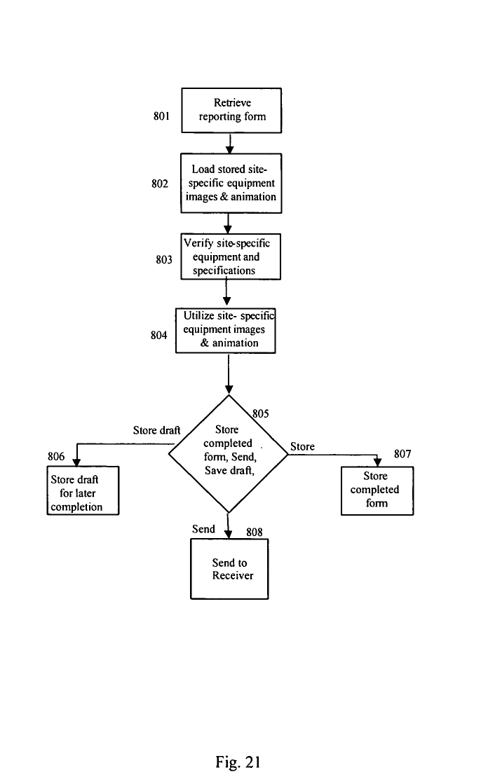

Referring now to FIG. 21, there is shown a method for utilizing site-specific images and relative specification information to complete reporting forms according to the present invention. At step 801, a determination is made regarding whether or not the user requires assistance for processing reporting requirements after the user has retrieved a reporting form. If the user decides assistance is necessary, the user can retrieve site-specific equipment image selections and specifications, previously identified and stored within the gaming sequences in step 802.

In one or more embodiments, the site-specific equipment images can be stored in XML format. In such embodiments, universally unique identifiers (UUIDs) and other signatures can be used to match the user's site-specific equipment images with the exact mandatory requirement request. Pre-assigned UUIDs uniquely identifying object data within the forms such as entry-point vectors, are used to verify the stored image with the requirement match within the form in step 803.

In one exemplary embodiment, if the user is unsure of the settings of the overfill restrictions for a required device, the user can access animation resources (abbreviated as symbol “A” in the figure) in step 804, to clarify and or explain information requirements directly within the electronic format by clicking on the equipment image (abbreviated as symbol “E” in the figure) in some embodiments of the present invention. If the user requires more help assistance, the user can also return to the demonstration, simulation or experiential sequences within the gaming application.

In step 805 the user is prompted as to whether the data form is complete. If the user is finished, the user proceeds to step 807 or step 808 where the form is stored to memory and or sent to a respective receiver in accordance with the hardware and operating environment illustrated in FIG. 2 If the user has not completed the form but wants to keep the current work, a draft copy of the form is saved for later access in step 806.

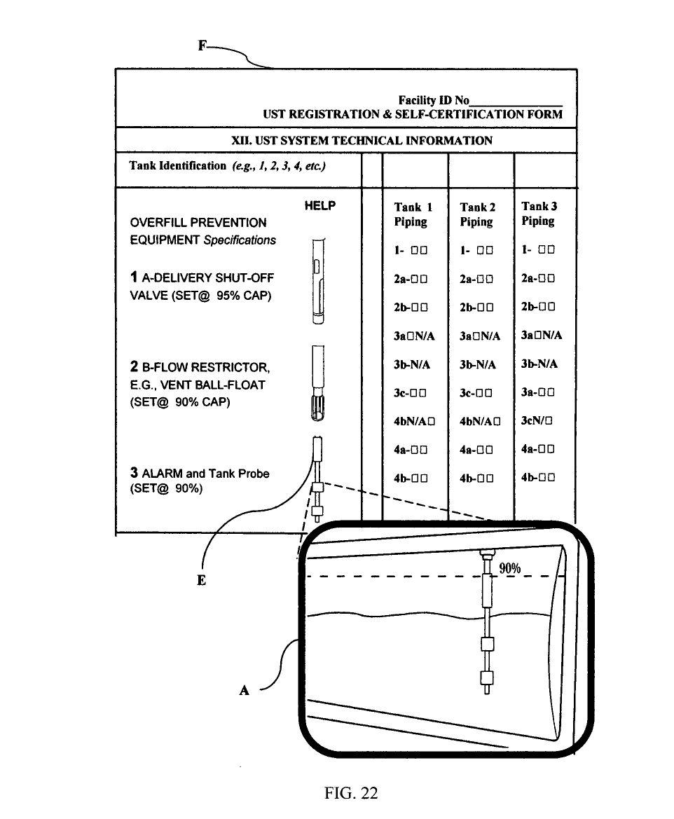

Referring now to FIG. 22, there is shown an illustration of the incorporation of site-specific equipment images and resource links within a reporting form (abbreviated as symbol “F” in the figure) according to the present invention.

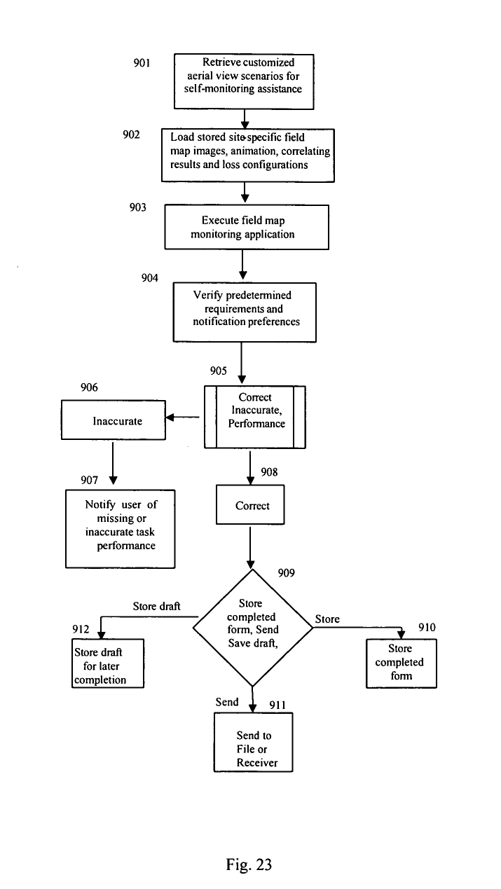

Referring now to FIG. 23, there is shown a method for assisted self-monitoring of required procedure and tasks according to an exemplary embodiment of the present invention. Further customization can be conducted regarding pre-assigned monitoring type, procedure/task scheduling and player/user notification preferences. Monitoring practice or advisory mode is conducted in real-time. As the player is assumed to have transitioned from a novice to an expert upon the successful completion of Level 3 (Experiential), detailed schematics as depicted in FIG. 18, while accessible, are not required.

In step 901, a determination is made regarding whether or not the user requires assistance for conducting self-monitoring. If the user decides assistance is necessary, the user can retrieve pre-determined aerial view scenarios in step 902, to form site-specific field map scenarios and animations to be accessed through a wireless device as illustrated in FIG. 2.

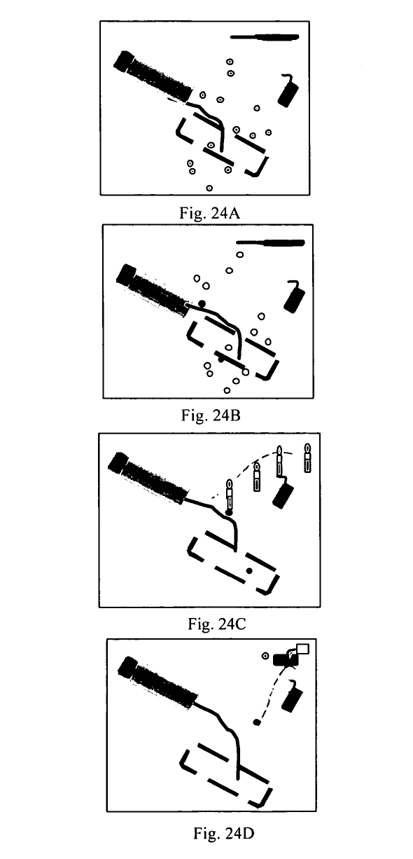

At 903, the player has selected to self-monitor the tasks required for a product delivery previously described and illustrated in FIG. 11. The schematics in the field map serve as a mental model of the 14 steps in the delivery product procedure. At 904, the user verifies predetermined requirements and notification preferences, that can include sound, telephone callback or both sequential notification of all methods. After 904, the user begins self-monitoring implementation. The remaining steps are described in FIG. 24A-D.

Referring now to FIG. 24A, there is shown an illustration incorporating a pre-assigned field map to support self-monitoring on a wireless device according to the present invention. The predetermined tasks are denoted as filled circles. As the user progresses to each task, the user can designate that the task has been completed, by interaction with a device appropriate interface to include: keying in task related number or tapping the task through a touch screen, retrieving digital type image that is matched to an image previously retrieved during customization and that has been programmed to interface with the user's camera on user's cell phone, or receive sensor signal (infrared, laser and/or accelerometer) depending on wireless device capability. In step 905, performance is processed, all completed task indicators un-fill in step 908.

Referring now to FIG. 24B, there is shown an illustration of the predetermined tasks that are performed out of sequence or are not performed at all, step 907, which turn red and the user is notified in step 907.

Referring now to FIG. 24C, there is shown an iconic representation of a person which is animated back and forth across the display until the task is noted as being addressed. If a task goes unaddressed for more than a pre-assigned time the resource key is replaced with the potential problem that may result. In this case, a person to oversee product delivery was not assigned.

Referring now to FIG. 24D, there is shown an iconic representation of the signage and a leaking tank in accordance with an exemplary embodiment of the present invention. If the user had denoted the posting of signage to notify the delivery person of the type of overfill present at the site, would appear until the task was noted as being addressed. If the user has indicated further notification through a call-back, the user's wireless device will ring and provide user with a pre-assigned and recorded personal message as to the consequence gravity. For example in the present example, the pre-recorded message the user has assigned to his or her self is, “Remember, to change signage to note new equipment upgrade.” If the user does not address either of the incomplete tasks, they will continue to notify the user in accordance with pre-assigned interval.

In step 909 the user is prompted as to whether the data form/file regarding the self-monitoring was used in this instance and if it is complete. If the user is finished, the user proceeds to step 910 or step 911 where a required form or “best practice” record, is stored to memory and or sent to a respective receiver in accordance with the hardware and operating environment illustrated in FIG. 2.

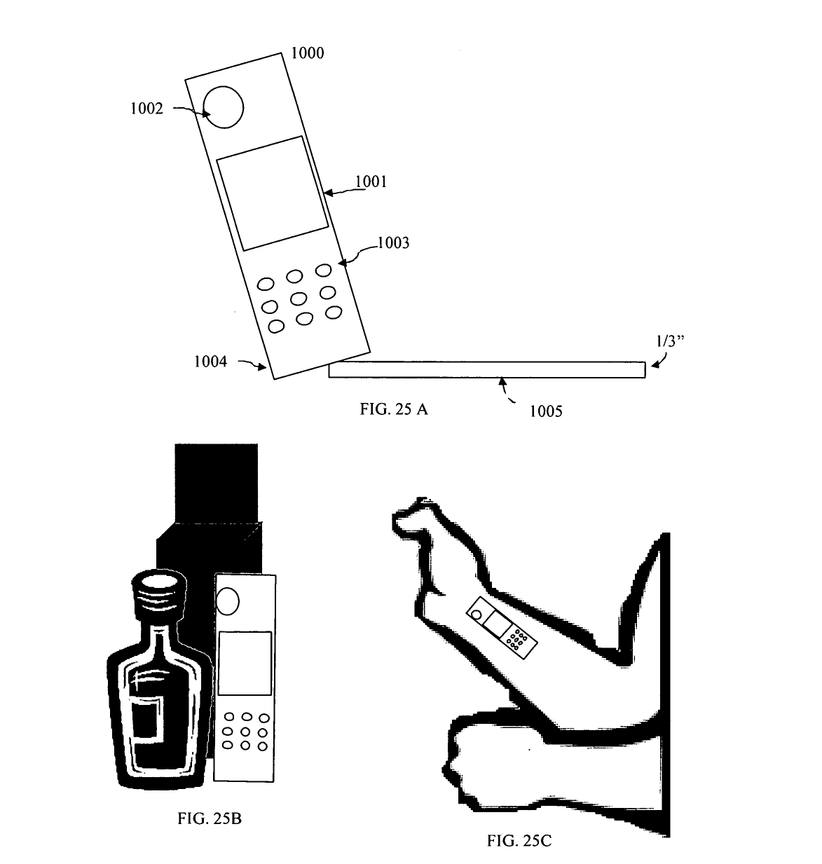

Referring now to FIG. 25A, there is shown an illustration of one exemplary embodiment of a temporary dermal communication device and operating environment in conjunction with which the instructional game of this invention may be practiced. The hardware environment is a wireless communication component 1000 which includes an LCD display 1001, speakers 1002 for both listening and speaking, a key interface unit 1003, and a pliable package (to include circuitry, conductors, energy source to also include solar cell, Flash memory and components) within a silicon substrate 1004 backed with an hypo allergenic adhesive 1005 and is approximately 2 inches by 3 inches and one third inches in size. Software for operating the communication device is written in C++ on the Symbian operating system.

In addition, to the specific embodiment details of a hardware and operating environment shown in FIG. 2, in which the instructional game of the present invention may be practiced, the device 1000 may also operate in an environment using Session Initiation Protocol (SIP) and Real-time Transport Protocol (RTP).

For example, in the present illustration, the administration of some medications at a specified time is critical to prevent the occurrence of new multi drug-resistant cases as well as measures to control existing cases (i.e. HIV and TB). As it relates to the present invention, treatment information can be delivered through an instructional game application, regarding a step-by-step treatment regime, simulations of care and consequences of adverse effects as previously described in game sequences to include a demonstration and simulation instruction and aerial field map monitoring and notification.

Referring now to FIG. 25B, there is shown an illustration of a second exemplary embodiment of a temporary dermal communication device and operating environment in conjunction with which the instructional game of this invention may be practiced. The use of the temporary dermal communication device accompanies a medication prescription.

Referring now to FIG. 25C, there is shown an illustration of a third exemplary embodiment of a temporary dermal communication device and operating environment in conjunction with which the instructional game of this invention may be practiced. The protective covering from the back of the device is removed and then placed on the underside of the patient's forearm.

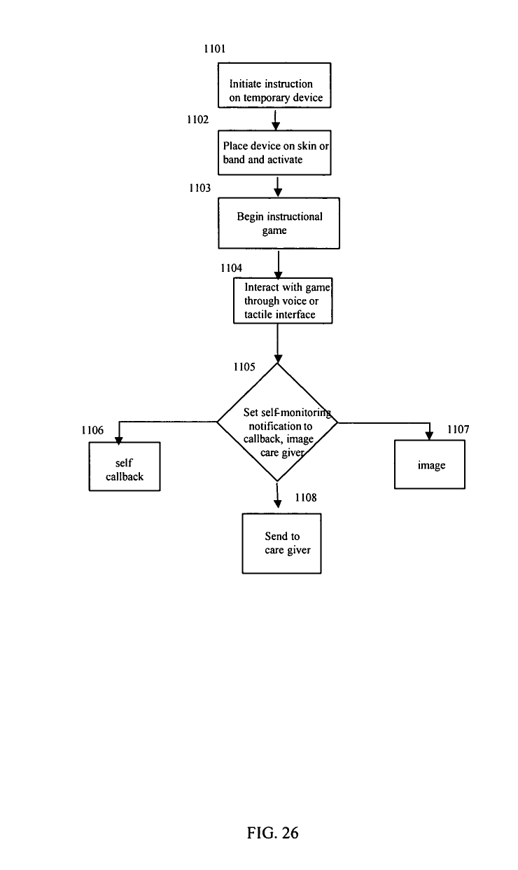

Referring now to FIG. 26, there is shown a method for describing a method for a temporary dermal communication device according to an exemplary embodiment of the present invention. As the care giver assists the patient with instruction regarding the specific treatment regime, as step 1101 begins with the initiation of instruction on the temporary device. At 102, the device is placed on skin or a band and activated.

At 1103, power activation is implemented and the patient views instructional presentations regarding the task of compliance with treatment regime at set time daily and the expected consequences if patient should not adhere to the regime.

In a second exemplary embodiment, the patient can interact through voice and/or key interaction during the instructional game in step 1104. In a third exemplary embodiment, upon completion of the instruction in step 1105, the care giver assists the patient set the self-monitoring feature which can include a self assigned callback message, step 1106 that is set to occur at the designated time and a image from the aerial field map, step 1107, that will continue to activate should the patent not enter the appropriate time confirmation in response to compliance notification. Should time exceed a pre-determined interval, the notification call-back can also be set to communicate with the care giver in step 1108.

As used herein, a hardware system can include discrete semiconductor devices, an application-specific integrated circuit, a field programmable gate array, a general purpose processing platform, or other suitable devices. A software system can include can include one or more objects, agents, lines of code, threads, subroutines, databases, application programming interfaces, web browser plug-ins, or other suitable data structures, and can include two or more different lines of code or suitable data structures operating in two or more separate software applications, on two or more different processing platforms, or in other suitable architectures. In one exemplary embodiment, a software system can include one or more lines of code or other suitable data structures operating in a general purpose software application, such as an operating system, and one or more lines of code or other suitable software structures operating in a specific purpose software application. In another exemplary embodiment, a software system can be implemented as a distributed software system, on a different processing platform than that shown in the exemplary embodiments herein, or in other suitable manners.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A method for an instructional game program, comprising:
generating an instructional game through morphological field analysis of instructional game parameters;
customizing the instructional game through a static or dynamic image of a site-specific object or image;
correlating the site-specific object or image to a pre-assigned user-specific required task and procedure stored within the instructional game;
executing a demonstration game to identify and record an object specification requirement;
determining compliant performance, results and resource loss due to probable noncompliant actions;
executing an instruction resource supported reporting application within the game program to identify and record the object specification requirement; and
executing a self-monitoring application within the instructional game to practice and monitor task and procedural requirements.
